(19) United States
(12) Patent Application Publication
(10) Pub. No.: US 2008/0101365 A1
(43) Pub. Date: May 1, 2008

(54) Data Extraction for Networked Voice Communication Devices

(75) Inventor: Richard Dodd, Coral Springs, FL (US)

Correspondence Address: MG-IP Law, PLLC, PO BOX 1364, FAIRFAX, VA, 22038-1364, US

(73) Assignee: Avaya Technology LLC

(21) Appl. No.: 11/553,536

(22) Filed: Oct. 27, 2006

(51) Int. Cl. H04L 12/56

(52) U.S. Cl. 370/392; 370/401

(57) ABSTRACT

Methods and apparatuses extracting data from a networked voice communication device (NVCD) are presented. One apparatus presented includes a processor and memory which is functionally coupled to the processor. The memory has executable instructions for causing the processor to iterate over a plurality of IP addresses within a subnet, and for each iteration, access a networked device at an IP address, determine whether the networked device is a VoIP telephone satisfying at least one predetermined criterion, and extract operational data from the VoIP telephone based upon the determination. A method for extracting data from a (NVCD) is presented which includes searching a network for a device functionally coupled to the network, determining whether the device is ail NVCD satisfying at least one predetermined criterion, where the at least one predetermined criterion includes a manufacturer's name, and extracting data from the NVCD.

### BACKGROUND OF THE INVENTION

1. Field of the Invention

Embodiments of the invention generally relate to the management of networked voice communication devices (NVCD), and more particularly, to methods and apparatuses for extracting operational data therefrom. Specifically, embodiments of the invention are directed to extracting operational data which may be used for a variety of purposes, including asset management, alternative gatekeeper list determination, connection status, and network utilization assessment.

2. Description of the Background Art

Advances in reliability, performance, and cost effectiveness are motivating a transition to utilize packet switched networks for data traditionally carried over circuit switched networks. This trend can be readily appreciated in the area of voice communications, where Voice over Internet Protocol (VoIP) telephony is being used to supplement, and in some cases, replace, telephone networks based upon the Public Switched Telephone Network (PSTN).

The different nature of packet switched networking and circuit switched networking can motivate the use of new diagnostic tools to build, troubleshoot, modify, and maintain such networks. Because VoIP telephone networks can scale rapidly and become very large in size, the establishment and administration of such networks may utilize special purpose tools to make these tasks manageable. Such administrative tools may include various hardware and software utilities to obtain information from a variety of NVCDs, including VoIP telephones.

Therefore, in order to establish and effectively maintain packet switched systems used for voice communication, a need exists for ways to obtain operational data and other types of information from NVCDs which is currently unavailable using existing approaches.

### SUMMARY OF THE EMBODIMENTS

Embodiments consistent with the present invention are directed to methods and apparatuses for extracting data from Networked Voice Communication Devices (NVCDs). One embodiment presented is an apparatus directed to extracting data from a networked voice communication device, which includes a processor, and a memory, which is functionally coupled to the processor and has executable instructions for causing the processor to iterate over a plurality of IP addresses within a subnet, and for each iteration, access a networked device at an IP address, determine whether the networked device is a VoIP telephone satisfying at least one predetermined criterion, and extract operational data from the VoIP telephone based upon the determination.

Another embodiment presented which is consistent with the present invention is a method directed to extracting data from an NVCD, which includes searching a network for a device functionally coupled to the network, determining whether the device is an NVCD satisfying at least one predetermined criterion, where the at least one predetermined criterion includes a manufacturer's name, and extracting data from the NVCD.

In another embodiment consistent the present invention, a method directed to extracting data from a Voice Over Internet Protocol (VoIP) telephone is presented. The method includes accessing a networked device at all IP address, determining whether the networked device is a VoIP telephone satisfying at least one predetermined criterion, and extracting operational data from the VoIP telephone based upon the determination.

In yet another embodiment, a computer readable medium storing executable instructions for causing a processor to perform a method directed to extracting data from a networked voice communication device is presented, which includes iterating over a plurality of IP addresses within a subnet, and for each iteration, accessing a networked device at an IP address, determining whether the networked device is a VoIP telephone satisfying at least one predetermined criterion, and extracting operational data from the VoIP telephone based upon the determination.

### BRIEF DESCRIPTION OF THE DRAWINGS

Further aspects and advantages of the present invention will become apparent upon reading the following detailed description taken in conjunction with the accompanying drawings summarized below.

FIG. 1 shows a top-level exemplary flowchart depicting a method consistent with an embodiment of the invention.

FIG. 2A depicts an exemplary flowchart providing greater detail of data extraction methods consistent with various embodiments of the invention.

FIG. 2B depicts an exemplary flowchart providing using consistent with various embodiments of the invention.

FIG. 3 shows an exemplary flowchart providing additional details regarding management information base (MIB) scanning consistent with some embodiments of the invention.

FIGS. 4A-4C depict ail exemplary flowcharts showing methods for determining talk-time, a percentage of talk-listen time, and bandwidth consumed consistent with another embodiment of the invention.

FIG. 5 shows an exemplary block diagram of a Network Voice Communication System (NVCS) consistent with another embodiment of the invention.

FIG. 6 depicts an exemplary block diagram of a Networked Voice Communication Device consistent with various embodiments of the invention.

### DETAILED DESCRIPTION

Embodiments consistent with the present invention are more specifically set forth in the following description with reference to the appended figures. Wherever possible, the same reference numbers will be used throughout the drawings to refer to the same or like parts.

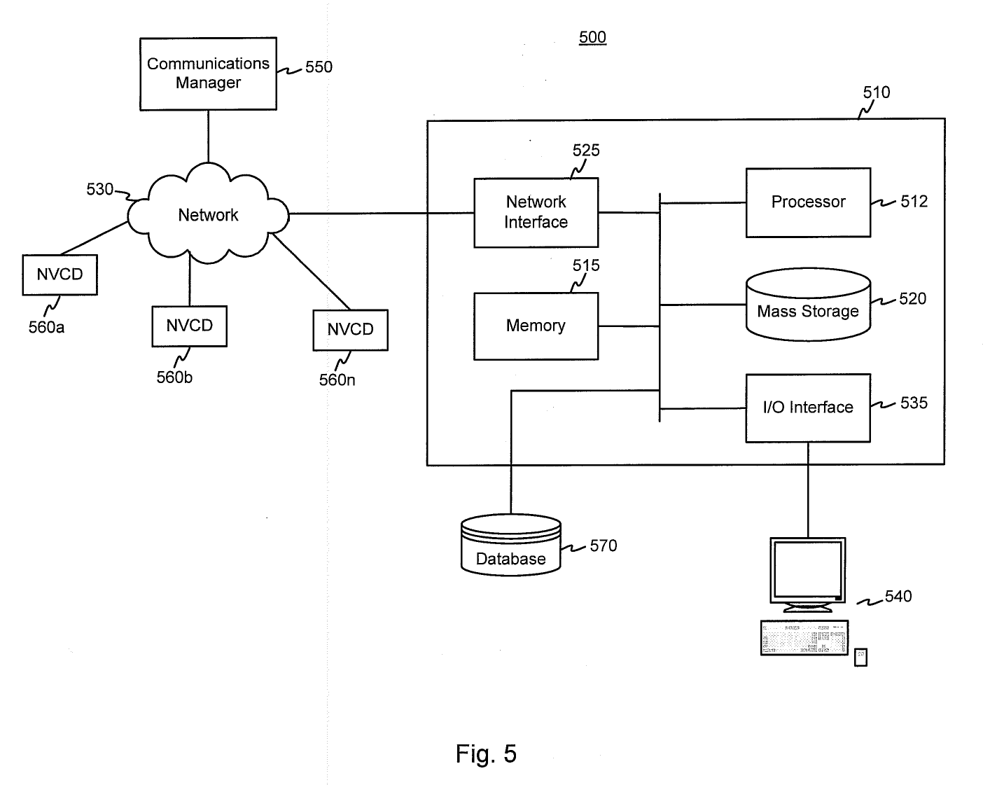

An exemplary Network Voice Communication System (NVCS) 500 consistent with an embodiment of the invention is shown in FIG. 5, which is described only briefly here as an introduction. NVCS 500 may include a diagnostic machine 510 which is functionally coupled to a packet switched network 530. Diagnostic machine 510 may be used to execute various embodiments for data extraction presented herein and presented in more detail below. A Communications Manager (CM) 550 and a plurality of Network Voice Communication Devices (NVCDs) 560a-560n may also be functionally coupled to packet switched network 530. CM 550 may organize and route voice, data, image and video transmissions. CM 550 may also connect to private and/or public telephone networks, Ethernet LANs, ATM networks, an-d/or the Internet. Commercially available versions, such as, for example, Avaya Communication Manager may be used in various embodiments of the invention. CM 550 allows centralization of call processing and administration though a single machine, and defines redundant gateways at remote locations using Alternative Gatekeeper Lists.

NVCDs 560a-560n may be voice transceivers providing voice communication capability to users through packet switched network 530. Details regarding the above-presented components of NVCS 500 will be described in more detail below.

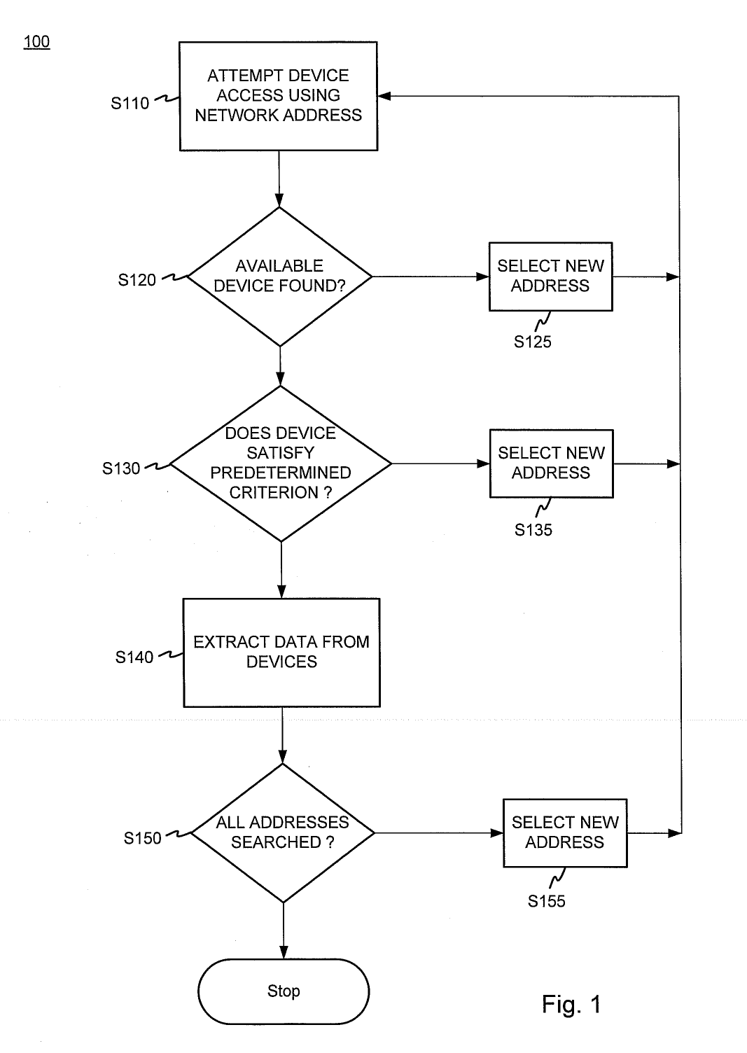

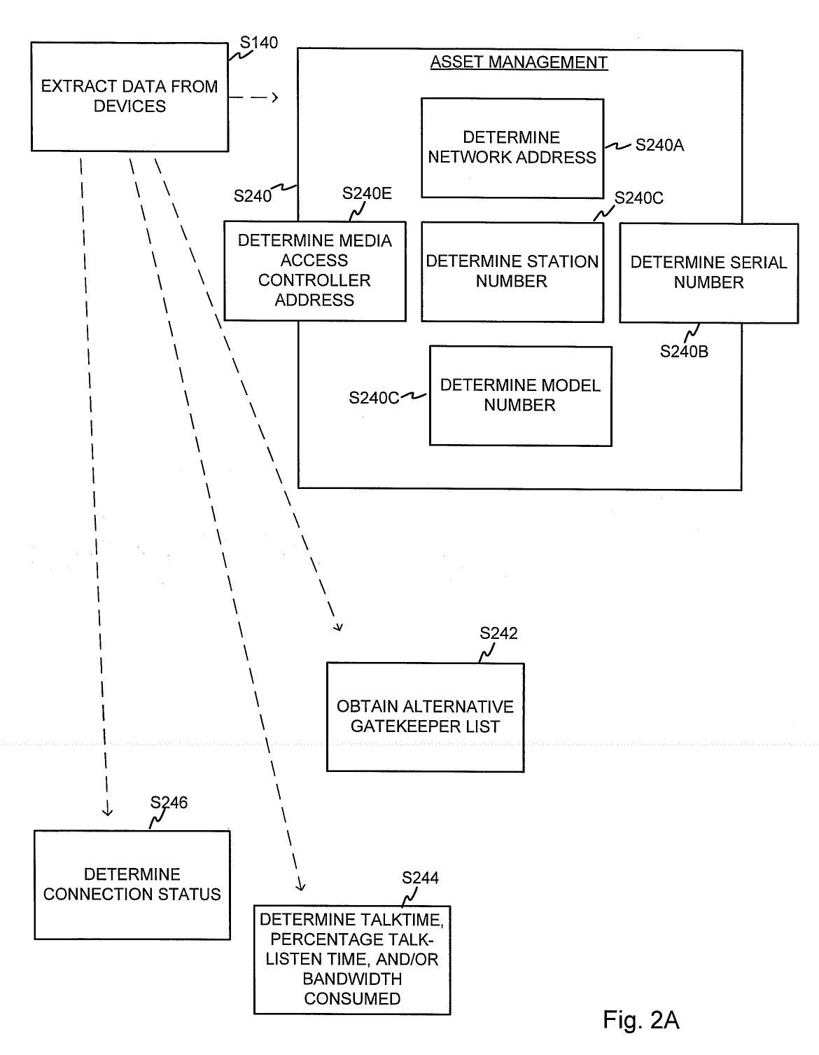

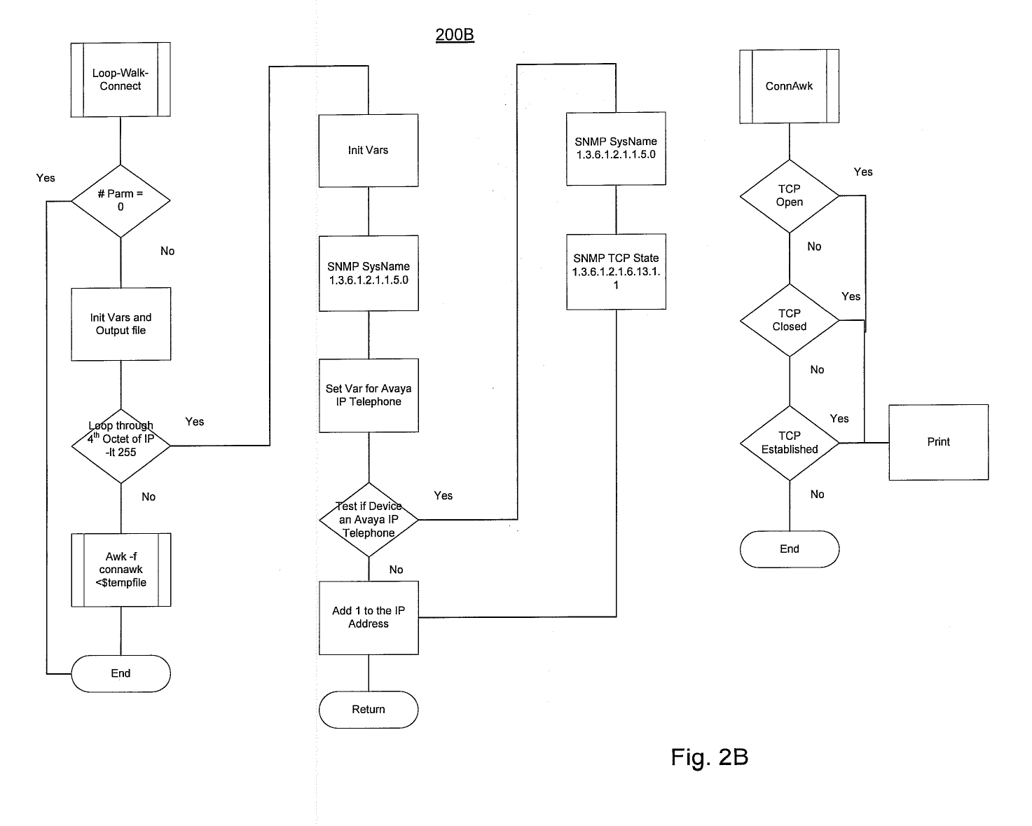

FIG. 1 shows a top-level exemplary flowchart depicting a method 100 consistent with an embodiment of the invention. Method 100 may begin by searching packet switched network 530 for a device which satisfies one or more predetermined criterion. This may be accomplished by initially attempting access to the device using a specific network address (S110). A determination can then be made if the device is found at the specified address (S120). If no device is available, a new address is selected and the attempting step S120 is repeated. Selecting step S120 may be accomplished by simply incrementing the network address, or by other methods known to one skilled in the art. If, on the other hand, an available device is found in step S120, another check may then be performed to determine whether the found device satisfies one or more predetermined criterion (S130). The predetermined criteria may include determining whether the found device is an NVCD, and if so, who manufactured the NVCD and/or any other designation describing one or more aspects the NVCD. If the found device fails to satisfy the predetermined criterion (S130), a new network address is selected (S135) and another attempt is performed (S110). If the found device satisfies the one or more criterion in step S130 (and thus it is determined that the found device is an NVCD), then data may be extracted from the NVCD in step (S140). The extracted data may be any type of data stored in the NVCD, and may include various types operational data which can conform to standards associated with packet switched network 530, and/or can be data particular to the NVCD itself. Details regarding the extraction step S140 and the data associated therewith are presented in FIG. 2A below. After the data has been extracted from the NVCD in step S140, a determination is made as to whether all network addresses of interest have been searched (S150). The method finishes if the network address search is complete, and if additional network address should searched, a new network address may be selected (S155) and the method repeats starting at step S110.

### Embodiments Using TCP/IP Networks

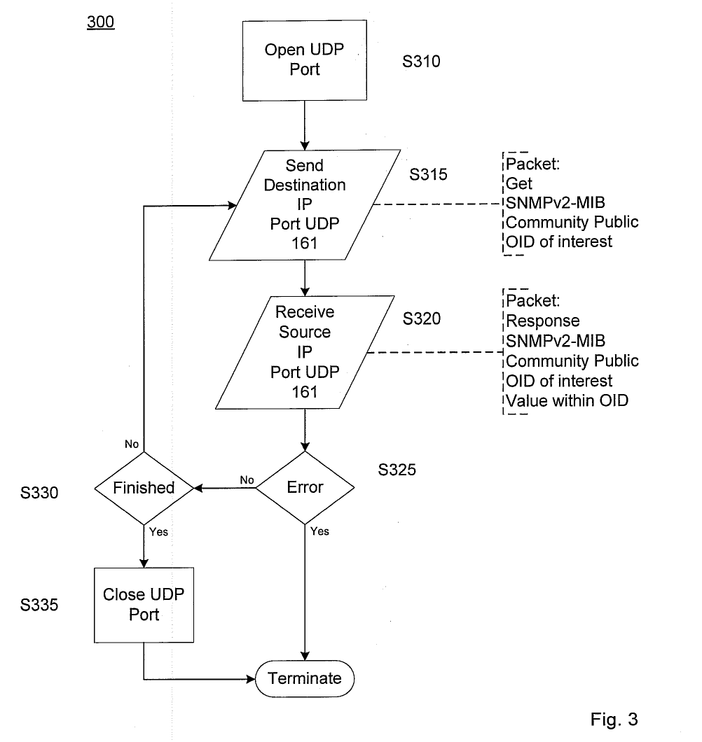

The following description presents various embodiments wherein packet switched network 530 may utilize TCP/IP, and NVCD's 560a-560n may include VoIP telephones. An embodiment may find VoIP telephones within the TCP/IP network by looping over IP addresses within an individual class-C subnet. The entire TCP/IP network of interest may then be searched one class-C subnet at a time. The method may start by attempting to access a device connected to the TCP/IP network, starting at a selected IP address which is the lowest address in the class-C subnet (S110). The attempt may be carried out by using techniques known to one of ordinary skill in the art, such as, for example, using the protocols under SNMP, which include performing a Management Information Base (MIB) walk at the selected IP address. MIB walks may be implemented using, by way of example only, “smpwalk,” or other techniques known to those skilled in the art. Details of performing MIB walks are presented below in the description of FIG. 3.

If a device is found at the selected IP address (S120), data may be read from an MIB residing on the device (which may be determined using the MIB walk process) and a check then be performed using the read data to determine if the found device satisfies one or more predetermined criterion (S130). Such criterion may include determining if the found device is a VoIP telephone, whether the VoIP telephone is made by a specific manufacturer, such as, for example, “Avaya,” and/or whether the VoIP is a specific model corresponding to the manufacturer (for example, an Avaya “46xx” and/or Avaya “96xx” VoIP telephones) (S130). This data may be stored in the MIB residing on the VoIP telephone, and can be accessed using the MIB walk technique. If the determining steps S120 and/or S130 are not satisfied, the last octet in the selected IP address may be incremented, and the method will return to step S110.

Once it is determined that the found device is a VoIP phone satisfying the at least one criterion, information may be extracted from the VoIP phone (S140). This information may take the form of operational data residing in the MIB of the VoIP phone, and the extraction may be performed using the same MIB walk techniques mention above. Various embodiments of the invention may extract different information from the MIB in step S140. As will be described in more detail below, an embodiment is presented which may extract asset management data; another embodiment may extract Alternative Gatekeeper Lists (AGLs); yet another embodiment may determine connection status with respect to the communication manager of the VoIP telephone; and another embodiment may determine talk/listen time and the bandwidth consumed of the VoIP telephone.

In step S150, a check is performed to determine if all of the addresses in the class C subnet have been searched. For a class C subnet, the last octet may not exceed a value of 255, therefore, step S150 may simply check to the last octet is greater than this value. If so, the method may stop searching the class C subnet, and, if desired, another class C sub net may be searched (not shown). If the last octet of the specific address is not greater than 255, the last octet of the specific address may be incremented, and the method may branch back to step S110 and reiterate. One of ordinary skill in the art would appreciate that networks of arbitrary size may be searched in the above described maimer one class C subnet at a time.

Method 100 may be initiated manually by a user by initiating a command, or be programmed for automatic execution by machine on a periodic basis. Manual execution may be useful for debug purposes during the development of the NVCS 500. Automatic execution may be set Up on a periodic basis, having a frequency that may depend upon the type information data being extracted from the NVCDs 560a-560n. For example, when extracting access management data, method 100 may be performed automatically once every month. When determining AGLs and/or bandwidth consumed, method 100 may be automatically performed one or more times every day for daily maintenance of the NVCS 500.

FIG. 2A depicts an exemplary flowcharts providing greater detail regarding the data extraction step S140 consistent with various embodiments of the invention. The data extraction step may include an asset management step S240, an obtaining AGL step S242, a determining connection status step S246, and determining talk-time, a percentage of talk/listen time, and/or bandwidth consumed step S244. Steps S240-S246 may be performed separately or in any combination. If the steps are being performed in some combination, any combination of these steps may grouped within a single iteration of the main loop of method 100. Alternatively, any combination of steps S240-S246 may be performed in a sequential maimer, wherein each of the steps in the combination can be looped separately through the main loop of method 100, and once finished, another step in the combination may separately iterated through the main loop. This can continue until all the desired steps are looped through one after another.

The Asset Management step S240 may extract data from one or more of NVCDs 560a-560n which can be used in the both the development and day-to-day maintenance of NVCS 500. Asset Management S240 may include determining a network address (S240A) from any of NVCDs 560a-560n. The network address may be based upon standards associated with packet switched network 530, and may be, for example, an IP address. By determining the network addresses of NVCDs 560a-560n, an administrator can better manage and allocate address resources across packet switched network 530. Toward this end, Media Access Controller (MAC) addresses may also be obtained from NVCDs 560a-560d (S240E). Asset Management step S240 may also determine model numbers (S240D) and serial numbers (S240B) from NVCDs 560a-560d. Model and serial numbers may be assigned by the manufacturer of an NVCD, and having this information from NVCDs across packet switched network 530 may be useful for determining equipment usage and maintenance upgrade schedules.

Finally, station numbers of NVCDs 560a-560n, are numbers which may be uniquely associated with a specific NVCD. Station numbers may be utilized by users to access other NVCDs within switched packet network 530, or used in conjunction other information for access by devices external to switched packet network 530. For example, station numbers may include extension numbers, such as, for example, a 4 digit number which may be used to access an NVCD by another user within a same office building. Access to the NVCD from outside the building may utilize a standard 10 digit phone number having the last four digits being same as the extension number. The station number may be uniquely associated with a particular NVCD, and if the NVCD is moved to another connection point having a different network address within packet switched network 530, or if the network address is reassigned to a different value using a dynamic addressing assignment scheme, the station number can remain static and be uniquely associated with the NVCD. Maintaining the same station number can be a convenient feature for users in that they do not have to memorize new extension numbers when their office location is moved. Tracking the station number may be useful for an administrator in managing, documenting, and planning NVCS 500, as specific NVCDs migrate about a facility and access switched packet network 530 using different network addresses.

Extracting data from devices step S140 may further include obtaining Alternative Gatekeeper Lists (AGLs) step S242. An AGL is a list of switched packet network address of various points in the NVCS 500 where NVCDs 560a-560n can register to Communications Manager (CM) 550. The registration process can facilitate user mobility by allowing the user to remain associated with a single station number while using various NVCDs. For example, if a user wishes to have his extension ring at a remote location utilizing a different NVCD, the user may register that NVCD to receive calls there. Alternatively, if a user wishes to use a software based phone on a personal computer, the software based phone may be registered with the user's station number.

Registration may be defined as the process of having CM 550 associate a station number with a particular NVCD by having a user log into the NVCD using, for example, a station and a password. Using this information, CM 550 may validate the particular NVCD with the station number. If the user no longer wishes to use that particular NVCD, the association may be terminated by having the user log off. An AGL may be dynamically built by CM 550 at registration time, and, once created, the AGL may then be downloaded to NVCDs 560a-560d over switched packet network 530 to be stored in an NVCD itself. After being stored in an NVCD, CM 550 may typically discard the AGLs. Because CM discards the AGLs, there is no central location from which AGLs can be obtained by an administrator, thus motivating the need for utilizing step S242.

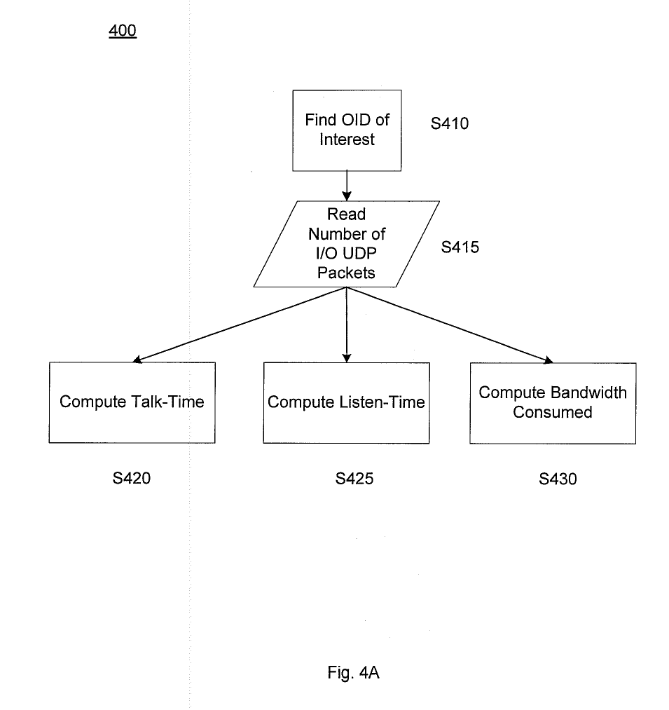

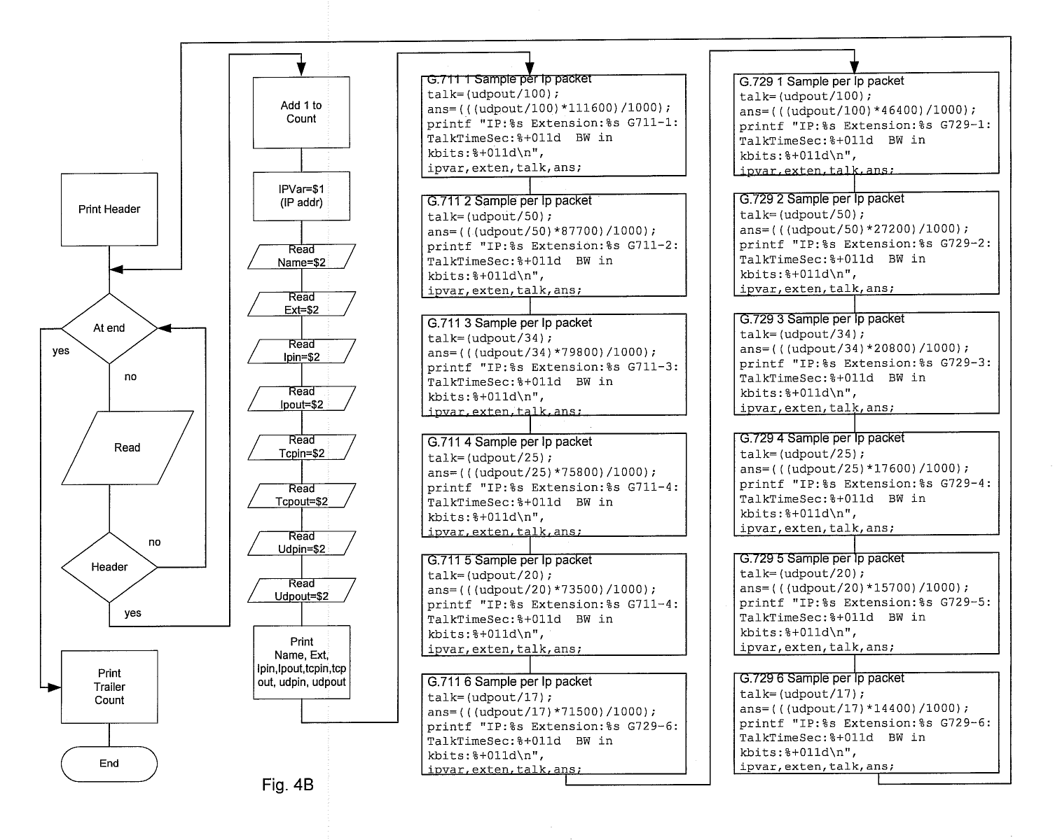

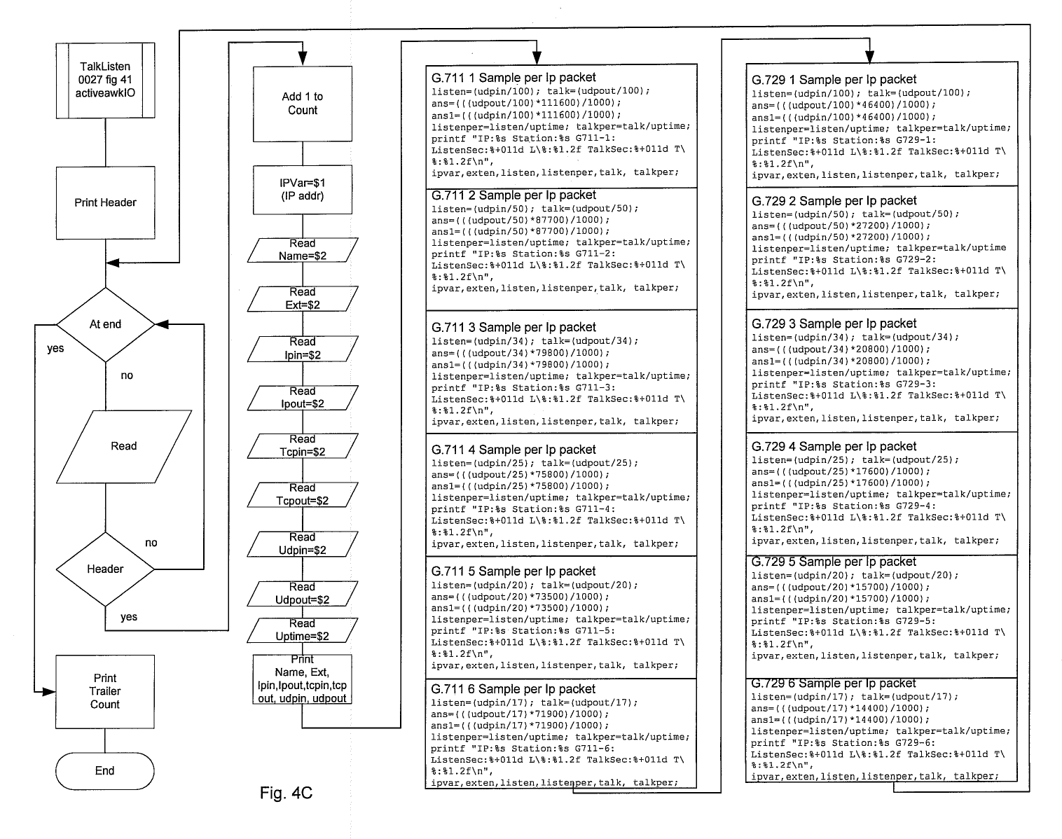

Extracting data from devices step S140 may further include the step of determining talk-time, the percentage of talk/listen time, and/or bandwidth consumed (S244). Talk time and listening time is the amount of time which is an NVCD is used for talking and listening, respectively. It may be computed by obtaining the amount of data cumulative input and output to the NVCD, and utilizing algorithms known in the art to convert the amount of input and output data into a time values. Talk time, listen time, and percentage of talk/listen time may be used to determine NVCD usage and/or monitoring the amount of time individuals using the NVCD. The percentage of talk/listen time can be a useful metric for the evaluation of employee performance, for example, the performance of agents at a call center. An additional metric which may be computed is the amount of bandwidth consumed by the NVCD, which also may be determined by the amount input and/or output data utilized by the NVCD using algorithms known in the art. Bandwidth consumed can be a useful metric for determining the load on switched packet network 530. Details regarding how this is performed are presented below in the description of FIGS. 4A-4C.

Finally, extracting data from devices step S140 may further include determining a network collection status of any of NVCDs 560a-560n (S246). The connection status may include three network states: 1) “Listening”—when an NVCD is connected to switched packet network 530 and is awaiting with its ports opened; 2) “Closed”—when an NVCD is connected to switched packet network 530 but is not yet registered to CM 550; and 3) “Established”—when an NVCD is connected to the network and is registered to CM 550. The connection status information may be very useful to determine which NVCDs 560a-560n are not registered to CM 550. For example, an administrator may determine if a particular NVCD is unregistered if its connection status is in the “Listening” or “Closed” state. Moreover, by utilizing the network address (e.g., IP address), the administrator may be able to locate the NVCD within the switched packet network 530 and determine the NVCD's physical location. Utilizing these network states can provide a convenient and efficient way to determine which NVCDs 560a-560n are unregistered and further determining their physical location, which may be very useful for administering, configuring, and debugging the NVCS 500.

FIG. 2B shows an exemplary flowchart for a method 200B consistent with another embodiment of the invention. Method 200B is a different embodiment of method 100, and may utilize TCP/IP network protocols and a specific predetermined criterion for NVCD. There, the process Loop-Walk-Connect loops over the 4^{th} octet of IP addresses to search for an NVCD which may be a VoIP telephone manufactured by Avaya. Once an Avaya VoIP telephone is found, information may be extracted from the phone as presented above. All of the addresses from 0-255 are tested in the class-C subnet for Avaya VoIP telephones. Once the class-C is completely searched, the process terminates, and other class-C subnets may be searched. The sub-process ConnAwk may be used to provide an output listing of each VoIP telephone and its associated parameters.

FIG. 3 shows an exemplary flowchart providing additional details regarding management information base (MIB) scanning consistent with some embodiments of the invention. A MIB is a collection of hierarchically organized information which may stored in a NVCD. The information stored in the MIB can be organized in a tree-like structure which may contain objects describing information regarding the NVCD. The objects may have associated object identifiers to provide efficient access to information stored within the MIB. The MIB may be accessed using network management standards defined under the Simple Network Management Protocol (SNMP), and may include SNMP walks. SNMP walks can query the tree-like structure for information associated with objects using specified object identifiers of interest. A top-level flowchart, which outlines a method which may be performed on diagnostic machine 510 for performing an SNMP walk 300, is exemplified in FIG. 3.

Initially, method 300 starts by opening a UDP port on a device (S310) which is connected to network 530 and accessed using a specific IP address. This port is typically port UDP 161, but other ports known by one of ordinary skill in the art which may be utilized with SNMP can be used. Then a command is sent to the device instructing it to provide specific information, using a designated IP address (which may correspond to the IP address of diagnostic machine 510), through the open UDP port on the device (S315). This requested information may reside in the MIB on the device, and may be accessed by using the appropriate Community Public Object Identifier (OID) of interest. The OID may be standard identifies, or may be identifiers designated by manufactures and/or programmers of the device, which are used to designate specific portions of data in the MIB. The device itself may access its MIB using standard methods known to one of ordinary skill in the art. Once the data corresponding to the OID is accessed, the device then responds by sending the requested information of interest, which is received at the provided IP address of diagnostic server 510 (S320). A check may then be performed to determine if an error occurred in steps S315 and/or S320, if so, the method may terminate (S330). If not, another determination may then made whether additional information corresponding to other OIDs is to be obtained (S330). If so, steps 315, 320, and 325 are repeated, and if not, the UDP port is closed (S335) and method 300 may terminate. Standard commands, such as those provided under SNMP, may be used to send the information request to the device obtain information in the MIB with the OID of interest.

One of ordinary skill in the art would appreciate that other embodiments of the invention may utilize standard SNMP tools to perform MIB scanning, such as for example, the program “snmpwalk.” Snmpwalk may be run through a command line interface within a shell of an operating system, such as, for example, the Bash shell running under Linux and/or Unix.

FIG. 4A depicts a top level exemplary flowchart showing methods for determining talk-time, the percentage of talk-listen time, and/or bandwidth consumed consistent with another embodiment of the invention. Within the MIB, the number of User Datagram Protocol (UDP) packets, which have been input and output from the NVCD, may be accessed by diagnostic machine 510. This may performed by first accessing the MIB stored in the NVCD's memory, which can be done by finding the OID corresponding to the number of input-output UDP packets (S410). Once the location corresponding to the input-output packets in the MIB is found, the values are read from the MIB (S415). Based upon the number of input and output packets, the duration for which the phone has been used, referred to herein as “listen-time” and “talk-time,” may be computed (S420 and S425). Talk-time is the duration of time for which a user has been using the NVCD to talk, and listen time is the duration of time for which a user has been using the NVCD to listen. The talk-time and bandwidth consumed may be used by a network designer in construction the network, and/or be used by a network administrator in the day-to-day maintenance of the network.

By determining the talk and listen time, it may be an easy matter to compute a metric, such as, for example, a percentage, comparing the talk time versus the listen time of the NVCD. This metric may be determined from the number of input and output UDP packets is the percentage of talk/listen time versus connect time. This metric may be useful in evaluating call centers to determine if call-center agents are doing more talking than listening, or vise-versa.

Algorithms known to those skilled in the art which may be used to determine bandwidth for VoIP systems may be modified to determine listen-time and talk-time. These algorithms may depend on the codec(s) being used by the NVCD. Another metric which may be computed from the number if input and output UDP packets may be the amount of bandwidth consumed by the NVCD (S430). The bandwidth consumed may be computed using algorithms known in the art, which may depend upon the codec(s) the NVCD is using. Details of method 400 are further exemplified in FIGS. 4B and 4C. FIG. 4B shows details regarding determining talk-time and bandwidth consumed (showing exemplary formulae for talk-time and bandwidth consumed for different codec's G.711 1 through G. 711 6 and G.729 1 through G.729 6). FIG. 4C shows details regarding determining percentage talk/listen time using exemplary formulae associated with different codec's G.711 1 through G. 711 6 and G.729 1 through G.729 6.

FIG. 5 shows an exemplary block diagram of a Network Voice Communication System (NVCS) 500 consistent with another embodiment of the invention. NVCS 500 may include diagnostic machine 510, packet switched network 530, CM 550, and NVCDs 560a-560n. CM 550, NVCDs 560a-560n, and diagnostic machine 510 all may interface with packet switched network 530.

Diagnostic machine may include processor 512, system bus 518, mass storage unit 520, I/O interface 535, memory 515, and network interface 525. Processor 512 may interface with memory 515 and mass storage unit 520 via system bus 518. Memory 515 and/or mass storage unit 520 may contain executable instructions and data for implementing the steps in method 100. Network interface 525 may interface with processor 512 over system bus 518, and provide an interface for communication with external devices, such as NVCDs 560a-560n, over packet switched network 530. An I/O interface 535 may be provided to permit a user to interface to diagnostic machine 510 via user interface 540. Processor 512 may further communicate with either an internal and/or external database 570, which may be used to store the results of program execution suitable for database applications. For example, asset management results could be presented as output delineated by colons as field separator for import into applications such as, for example, Microsoft Excel, Microsoft Access, Oracle, etc. Output may also be provided on terminal within user interface 540 interactively, or off loaded for reporting or archive purposes.

Diagnostic machine 510 may be a management server or client device. One of ordinary skill in the art would appreciate that diagnostic machine 510 may be any type of computer utilizing any operating system. For example, processor 512 may be an x86 based CPU, and utilize any variant of the Linux operating system, further using, for example, the Bash shell, and the Perl scripting language for programming. Alternatively, digital machine 510 may be implemented as special purpose hardware. Other implementations could be based on portable form factors, for example, a Personal Digital Assistant, which may be useful for technicians and administrators troubleshooting NVCS problems in a remote location.

Switched packet network 530 may use any physical networking layer known in the art, such as, for example, twisted pair wiring, wireless implementations over 801.11x, etc., and/or any combinations thereof.

CM 550 may be a software module running which can run on a separate server (not shown) or may run on diagnostic machine 510 and residing in memory 515 and/or mass storage unit. In other embodiments, CM 550 may be implemented as a dedicated hardware module.

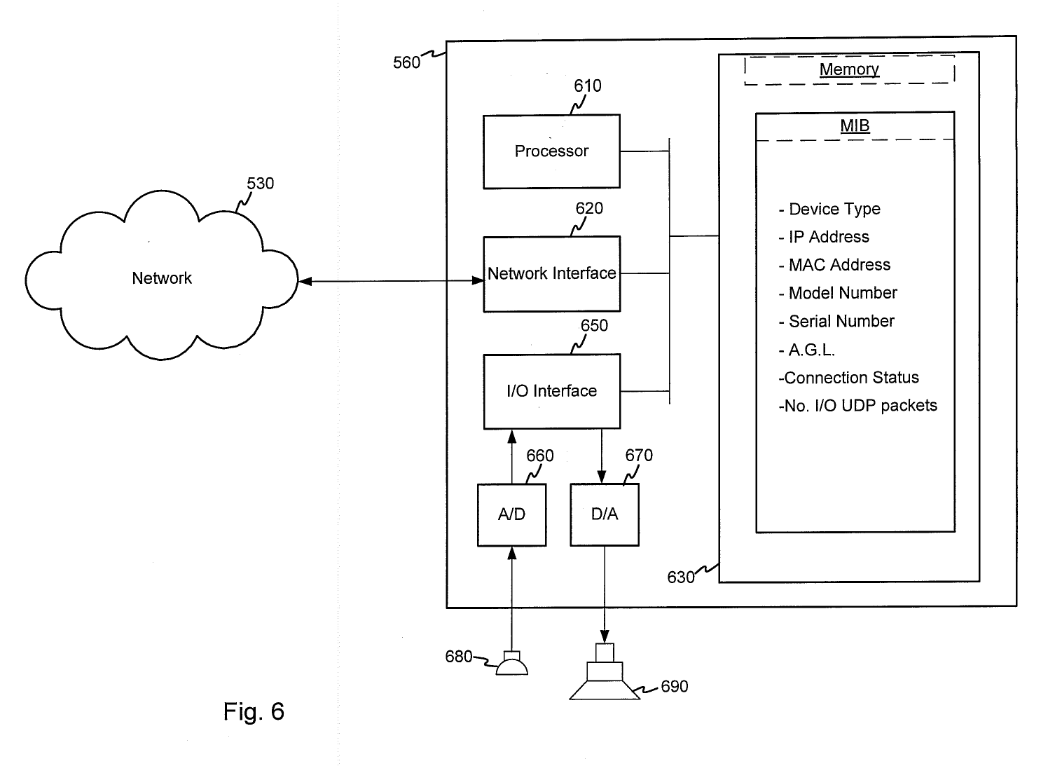

FIG. 6 depicts an exemplary block diagram of a Networked Voice Communication Device (NVCD) consistent with various embodiments of the invention. NVCD 560 may include at least one processor 610, a network interface 620, and a memory unit 630, each interconnected via an interface bus 640. At least one processor 610 may include general-purpose processors and/or Digital Signal Processing units. NVCD 560 may further include an I/O interface 650, connected to processor 630 via interface bus 640, and may be further interfaced to A/D unit 660 and D/A unit 670. A/D unit 660 may be further coupled to microphone 680, and D/A unit 670 may be further coupled to speaker 690. Voice input provided by a user may be converted to an electrical signal by microphone 680, and may be digitized by A/D 660. The digitized voice signal may be carried by I/O interface 650 to at least one processor 610 for various coding and processing functions, and subsequently sent over switched packet network 530 for voice communications with other party/parties. Incoming encoded digital voice signals may come over network 530 from other NVCDs 560a-560n, and pass through network interface 620 to at least one processor 610, where it may be decoded and sent to I/O interface 650. I/O interface 650 may pass the decoded digital voice signals to D/A converter, where the digital signal may be converted to an analog voice signal. The analog voice signal may then be played through speaker 690 so the user may hear other party/parties being in the conversation. Network interface 620 allows NVCD 560 to communicate with other devices (for example, diagnostic machine 510) over switched packet network 530.

Memory unit 630 may store the Management Information Base (MIB). MIB may further include various operational and other forms of data, including, for example: device type, I.P. Address, M.A.C. address, model number, Serial number, AGLs, connection status, and number of input/output UDP packets.

NVCD 560 may be any type networking voice communications device known to one of ordinary skill in the art. For example, NVCD 560 may be a VoIP telephone, such as, for example, an Avaya 46xx or 96xx unit. Alternatively, NVCD may be a software module (e.g., a soft-phone) running on a computer (e.g., a laptop, desktop, workstation, server, and/or etc.). NVCD 560 may be a portable device, such as, for example, a PDA or multi-function cellular telephone, a desktop handset, other wireless radio-telephones, or other devices using WiFi 801.11x or any other switched packet network known to one of ordinary skill in the art. One of ordinary skill in the art would appreciate that various embodiments of the invention described herein may also be utilized for networked communication devices transferring video and/or still image information, either alone or in combination with voice information.

Although detailed embodiments and implementations of the present invention have been described above, it should be apparent that various modifications are possible without departing from the spirit and scope of the present invention.

What is claimed is:

1. A method for extracting data from a networked voice communication device (NVCD), comprising:
searching a network for a device functionally coupled to the network;
determining whether the device is an NVCD satisfying at least one predetermined criterion, wherein the at least one predetermined criterion includes a manufacturer's name; and
extracting data from the NVCD.

2. The method according to claim 1, wherein the network comprises a TCP/IP network, and the NVCD comprises a Voice over Internet Protocol (VoIP) telephone.

3. The method according to claim 2, further comprising:
accessing sequentially devices functionally coupled to the network; and
obtaining information from a management information base (MIB) within the NVCD.

4. The method according to claim 3, wherein the at least one predetermined criterion comprises a VoIP telephone manufacturer name and/or a VoIP telephone model.

5. The method according to claim 3, wherein the obtaining further comprises reading from the NVCD an internet protocol address, a media access controller address, a VoIP phone model number, a serial number, and/or a communications manager assigned extension.

6. The method according to claim 3, wherein the obtaining further comprises reading from the NVCD an alternative gatekeeper list.

7. The method according to claim 3, wherein the obtaining further comprises determining a connection status of the NVCD.

8. The method according to claim 3, wherein the obtaining further comprises:
reading from the NVCD the number of User Datagram Protocol (UDP) packets input and output; and
determining a bandwidth consumed, talk-time, and/or percentage talk/listen time vs. connection time, based upon the reading.

9. All apparatus for extracting data from a networked voice communication device, comprising:
a processor; and
memory, functionally coupled to the processor, having executable instructions for causing the processor to
iterate over a plurality of IP addresses within a subnet, and for each iteration,
access a networked device at an IP address,
determine whether the networked device is a VoIP telephone satisfying at least one predetermined criterion, and
extract operational data from the VoIP telephone based upon the determining.

10. The apparatus according to claim 9, wherein the at least one predetermined criterion comprises a manufacturer name and/or a telephone model.

11. The apparatus according to claim 10 wherein the manufacturer name comprises “Avaya”.

12. The apparatus according to claim 9, wherein the executable instructions further cause the processor to obtain information from a management information base (MIB) within the VoIP telephone.

13. The apparatus according to claim 12, wherein the executable instructions further cause the processor to read from the MIB an internet protocol address, a media access controller address, a VoIP phone model number, a VoIP serial number, and/or a communications manager assigned extension.

14. The apparatus according to claim 12, wherein the executable instructions further cause the processor to read from the MIB an alternative gatekeeper list.

15. The apparatus according to claim 12, wherein the executable instructions further cause the processor to read from the MIB a connection status of the VoIP telephone.

16. The apparatus according to claim 12, wherein the executable instructions further cause the processor to
read from the MIB a number of input and output User Datagram Protocol (UDP) packets; and
determining a bandwidth consumed and/or talk-time based upon the reading.

17. A method for extracting data from a Voice Over Internet Protocol (VoIP) telephone, comprising:
accessing a networked device at ail IP address;
determining whether the networked device is a VoIP telephone satisfying at least one predetermined criterion; and
extracting operational data from the VoIP telephone based upon the determining.

18. The method according to 17, further comprising:
iterating over a plurality of IP addresses within a subnet, and performing the accessing, the determining, and the extracting for each IP address in the subnet.

19. The method according to claim 17, wherein the at least one predetermined criterion comprises a manufacturer name and/or a telephone model.

20. The method according to claim 19, wherein the manufacturer name comprises “Avaya”.

21. The method according to claim 17, further comprising obtaining information from a management information base (MIB) within the VoIP telephone.

22. The method according to claim 21, further comprising reading from the MIB an internet protocol address, a media access controller address, a VoIP phone model number, a VoIP serial number, and/or a communications manager assigned extension.

23. The method according to claim 21, further comprising reading from the MIB an alternative gatekeeper list.

24. The method according to claim 21, further comprising reading from the MIB a connection status of the VoIP telephone.

25. The method according to claim 21, further comprising:
reading from the MIB a number of input and output User Datagram Protocol (UDP) packets; and
determining a bandwidth consumed and/or a talk-time based upon the reading.

26. A computer readable medium storing executable instructions for causing a processor to perform a method for extracting data from a networked voice communication device, the method comprising:
iterating over a plurality of IP addresses within a subnet, and for each iteration;
accessing a networked device at an IP address;
determining whether the networked device is a VoIP telephone satisfying at least one predetermined criterion; and
extracting operational data from the VoIP telephone based upon the determining.
